(19) United States
(12) Patent Application Publication
(10) Pub. No.: US 2007/0048076 A1
(43) Pub. Date: Mar. 1, 2007

(54) Fastening system for a ring binder mechanism

(76) Inventor: Chun Yuen To, Hong Kong (CN)

Correspondence Address: SENNIGER POWERS, ONE METROPOLITAN SQUARE, 16TH FLOOR, ST LOUIS, MO, 63102, US

(21) Appl. No.: 11/216,907

(22) Filed: Aug. 31, 2005

(51) Int. Cl. B42F 3/00

(52) U.S. Cl. 402/70

(57) ABSTRACT

A ring binder mechanism comprises an elongate housing, at least one ring for mounting loose leaf paper, and at least one mounting structure associated with the housing. The mounting structure has a first end adapted for attachment to the housing and a second end having an aperture therein. A fastener is adapted for reception through the mounting structure aperture at the second end for securing the housing to a substrate.

### BACKGROUND OF THE INVENTION

This invention relates to ring binders for retaining loose-leaf pages, and in particular to a fastening system for attaching a ring binder mechanism to a cover to form the ring binder.

Conventional ring binders are made by securing a ring binder mechanism to a cover using rivets. Commonly, ring binder mechanisms include a housing and a plurality of ring members attached to the housing for retaining loose-leaf pages, such as hole-punched pages. Typically, the ring binder mechanism is secured to the cover by inserting the rivets through the cover and openings in the ring binder mechanism. The tail of each of the rivets is then deformed (e.g., by punching) to engage and fasten the ring binder mechanism. Once assembled, the ring binder is packaged and shipped to a distributor, a retailer, or directly to an end user (i.e., consumer).

One of the drawbacks of traditional ring binders relates to their shipping and storage after they are assembled. When assembled, large gaps exist between the ring binder mechanism and the cover for each ring binder leaving large amounts of room unused during shipping and storing of multiple ring binders. Thus, the number of ring binders in each package is greatly limited. As a result, packaging and shipping conventional ring binders is inefficient which results in significant shipping and handling costs. Moreover, even a limited number of ring binders occupy a substantial amount of storage space or retail display space.

In response to this drawback, manufacturers of ring binders typically pack the mechanisms in alternating directions. But even this packing technique leaves large amounts of unused space. Further efforts to overcome some of the short comings of conventional ring binders have been disclosed in coassigned U.S. Pat. No. 5,924,811 to To et al., U.S. Pat. No. 5,879,097 to Cheng, and U.S. Pat. No. 5,160,209 to Schuessler, all of which are hereby incorporated by reference in their entireties.

### SUMMARY OF THE INVENTION

In one aspect, a ring binder mechanism of the present invention generally comprises an elongate housing and at least one ring for mounting loose leaf paper. The ring includes first and second ring members. Each of the ring members are supported by the housing for movement relative to each other between a closed position in which the ring members form a substantially continuous, closed loop for allowing loose-leaf paper retained by the ring to be moved along the ring from one ring member to the other, and an open position wherein the ring members of the ring form a discontinuous, open loop for adding or removing loose-leaf paper from the ring. At least one mounting structure extends outwardly from the housing and has first and second ends. The first end is adapted for attachment to the housing and the second end has an aperture therein. A bearing element has an opening therein and a width greater than the width of the mounting structure at the second end. A fastener is adapted for reception through the washer opening and through the mounting structure aperture at the second end for securing the housing to a substrate with the bearing element generally interposed between the second end of the mounting structure and the substrate.

In another aspect, a ring binder mechanism of the present invention generally comprises an elongate housing and at least one ring for mounting loose leaf paper. The ring includes first and second ring members supported by the housing for movement relative to each other between a closed position in which the ring members form a substantially continuous, closed loop for allowing loose-leaf paper retained by the ring to be moved along the ring from one ring member to the other, and an open position wherein the ring members of the ring form a discontinuous, open loop for adding or removing loose-leaf paper from the ring. At least one mounting structure is associated with the housing. A snap fastener is constructed for snap connection with the mounting structure to secure the ring binder mechanism to a substrate.

In yet another aspect, a ring binder mechanism of the present invention comprises an elongate housing and at least one ring for mounting loose leaf paper. The ring includes first and second ring members supported by the housing for movement relative to each other between a closed position in which the ring members form a substantially continuous, closed loop for allowing loose-leaf pages retained by the ring to be moved along the ring from one ring member to the other, and an open position wherein the ring members of the ring form a discontinuous, open loop for adding or removing loose-leaf pages from the ring. At least one mounting structure extends outwardly from the housing and has first and second ends. The first end is adapted for attachment to the housing. A fastener is selectively engageable with the second end of the mounting structure for securing the ring binder mechanism to the substrate. At least one of the fastener and mounting structure is formed for nondestructive disengagement of the fastener with the second end of the mounting structure for releasing the ring binder mechanism from the substrate.

In still another aspect, a method of the present invention is generally directed to attaching a ring binder mechanism to a cover to form a ring binder. The ring binder mechanism generally comprises a housing including at least one ring for mounting loose leaf paper thereon and at least one mounting structure extending outwardly from the housing. The mounting structure has an aperture and the cover has at least one aperture therein. The method generally comprises the step of positioning a bearing element relative to the cover so that the opening in the washer is generally aligned with the aperture in the cover. The aperture is aligned in the mounting structure of the ring binder mechanism with the opening in the bearing element and the aperture in the cover. A fastener is inserted through the aperture in the cover, the opening in the bearing element and the aperture in the mounting structure to thereby secure the ring binder mechanism to the cover.

Other objects and features of the present invention will be in part apparent and in part pointed out hereinafter.

### BRIEF DESCRIPTION OF THE DRAWINGS

FIG. 1 is a fragmentary perspective of a ring binder including a cover and a ring binder mechanism attached to a spine of the cover, the ring binder mechanism being attached to the cover using a fastening system of the present invention;

FIG. 2 is the perspective of FIG. 1 with the ring binder mechanism exploded from the cover;

FIG. 3A is a section taken on line 3A-3A of FIG. 2;

FIG. 3B is a section similar to FIG. 3A but showing a washer and the ring binder mechanism engaging the cover, a fastener being partially inserted into the ring binder mechanism;

FIG. 3C is a section taken on line 3C-3C of FIG. 1;

FIG. 4 is a bottom side perspective of the ring binder mechanism;

FIG. 5 is an exploded perspective of the ring binder mechanism of FIG. 4;

FIG. 6 is the perspective of FIG. 4 but with the ring members in an open position;

FIG. 7A is an enlarged fragmentary perspective of the ring binder mechanism with a housing removed showing a lever connected to hinge plates;

FIG. 7B is a section taken on line 7B-7B of FIG. 7A;

FIG. 8A is a section similar to the section of FIG. 3C showing another configuration of a fastening system for attaching the ring binder mechanism to a cover;

FIG. 8B is an exploded view of the section shown in FIG. 8A;

FIG. 9A is a section similar to the section of FIG. 3C showing yet another configuration of a fastening system for attaching the ring binder mechanism to a cover;

FIG. 9B is an exploded view of the section shown in FIG. 9A;

FIG. 10A is a section similar to the section of FIG. 3C showing another configuration of fastening system for attaching the ring binder mechanism to a cover;

FIG. 10B is an exploded view of the section shown in FIG. 1A;

FIG. 11A is a section similar to the section of FIG. 3C showing a further configuration of fastening system for attaching the ring binder mechanism to a cover; and

FIG. 11B is an exploded view of the section shown in FIG. 11A.

Corresponding reference characters indicate corresponding parts throughout the several views of the drawings.

### DETAILED DESCRIPTION OF THE INVENTION

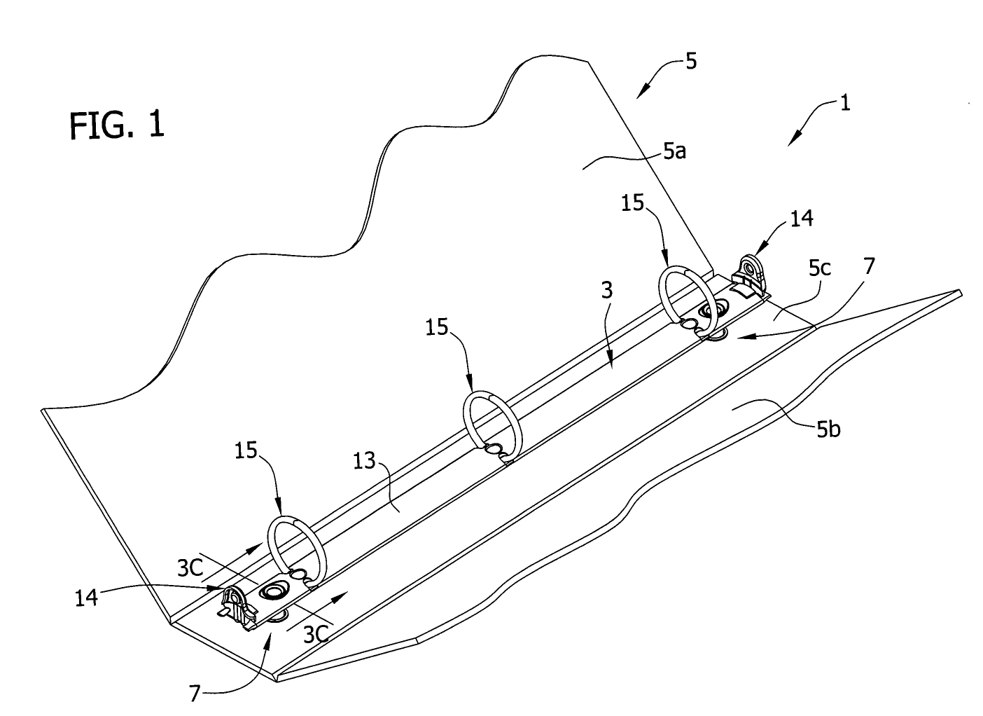

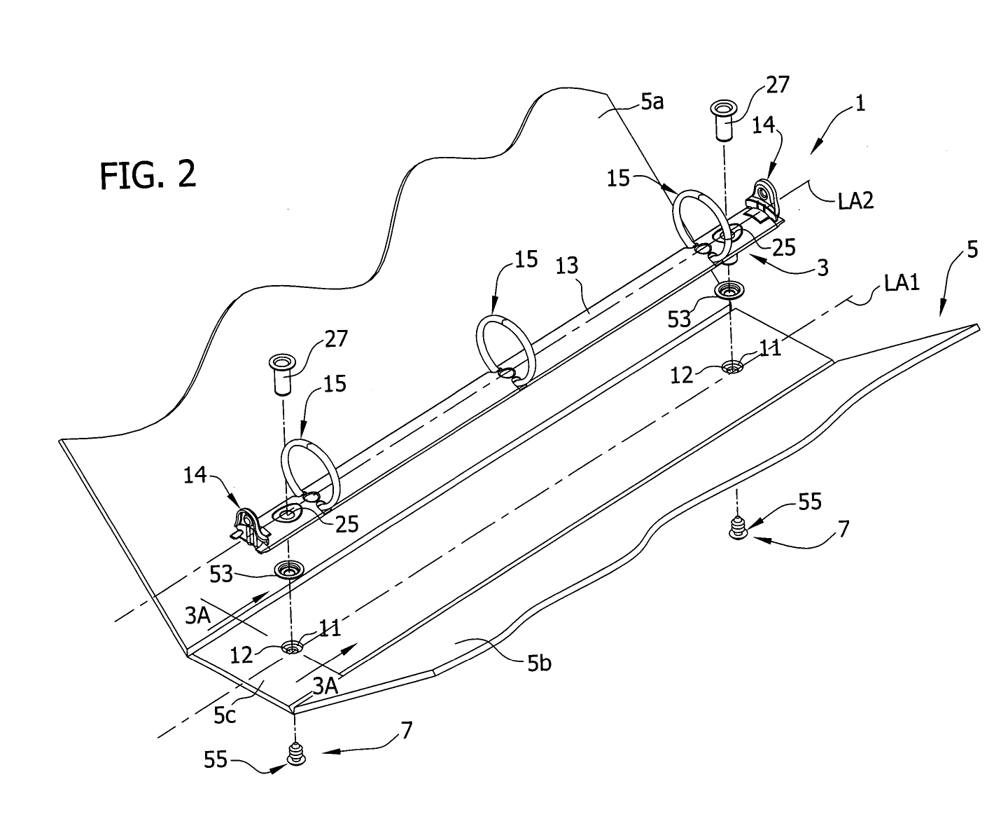

Referring now to the drawings, and particularly to FIGS. 1 and 2, a ring binder according to the present invention is designated generally by reference numeral 1. The ring binder 1 comprises a ring binder mechanism 3 affixed to a cover 5 (broadly, “a substrate”) using a fastening system 7 of the present invention. The cover, ring binder mechanism, and fastening system are indicated generally by their respective reference numbers. The cover 5 includes a front panel 5a, a back panel 5b, and a spine 5c. The front and back panels 5a, 5b are hingedly attached to the spine 5c so that they are movable to selectively cover or expose loose leaf pages (not shown) retained by the ring binder mechanism 3. The spine 5c of the cover includes, as shown in FIG. 2, two circular recesses 11 having apertures 12 therein for use in mounting the ring binder mechanism 3 to the cover 5. The number of recesses and apertures may be other than two within the scope of the present invention. The recesses 11 and apertures 12 are axially aligned along a longitudinal axis LA1 of the spine 5c so that, when attached, a longitudinal axis LA2 of the ring binder mechanism 3 is generally parallel to the longitudinal axis of the spine (FIG. 1). The recesses 11 and apertures 12 in the spine are described in more detail below. While the ring binder mechanism 3 is shown in FIG. 1 as being affixed to the spine 5c of the cover 5, it is understood that the ring binder mechanism can be affixed to the front or back panels 5a, 5b of the cover. Moreover, the ring binder mechanism 3 can be mounted on substrates other than the cover 5, such as files, without departing from the scope of the present invention.

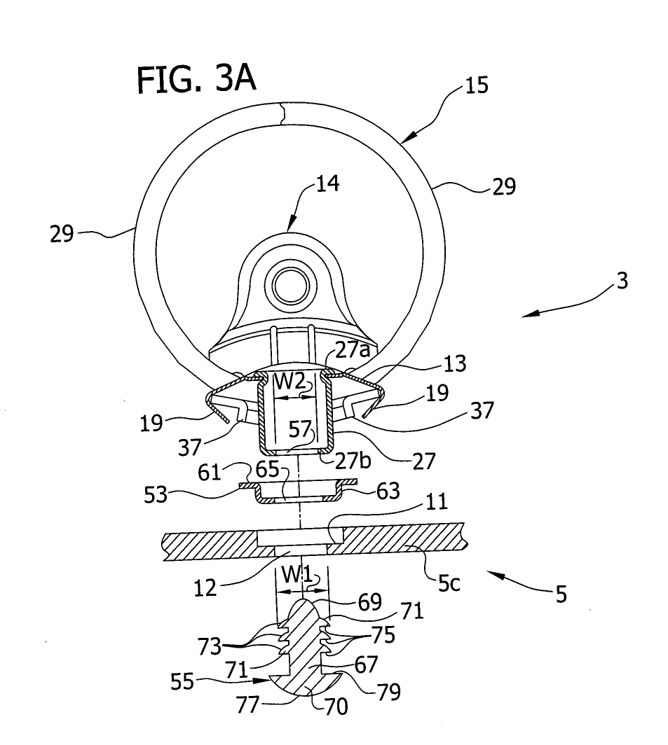

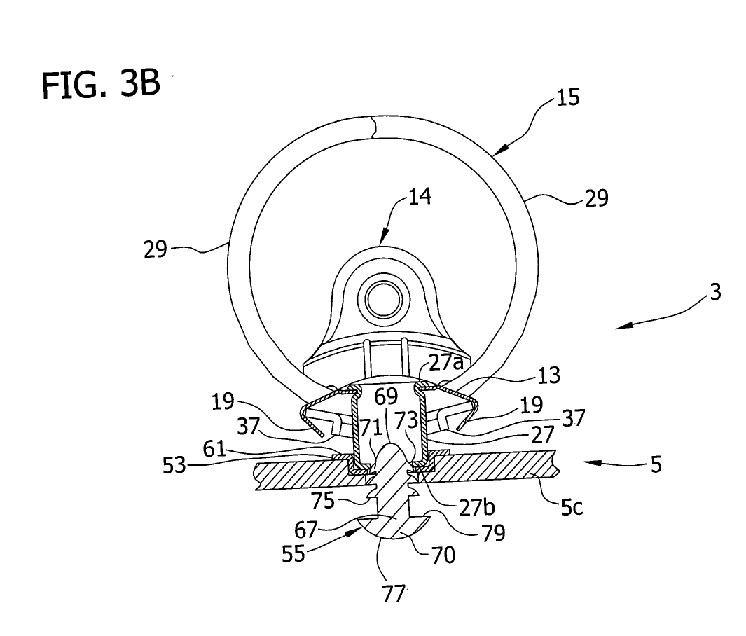

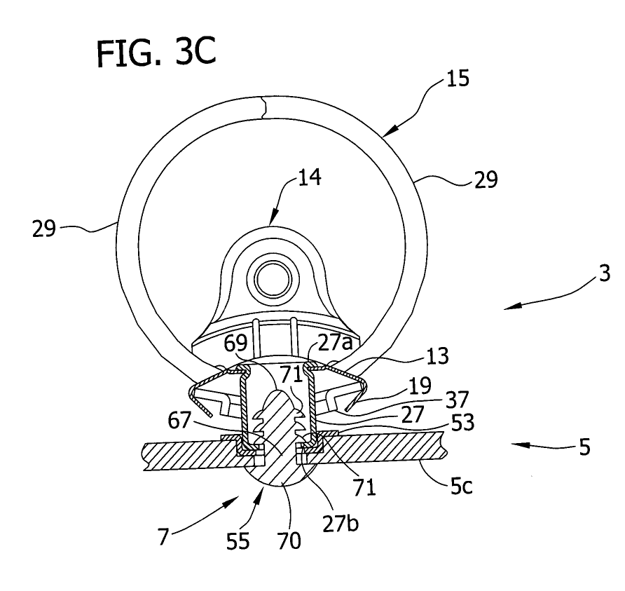

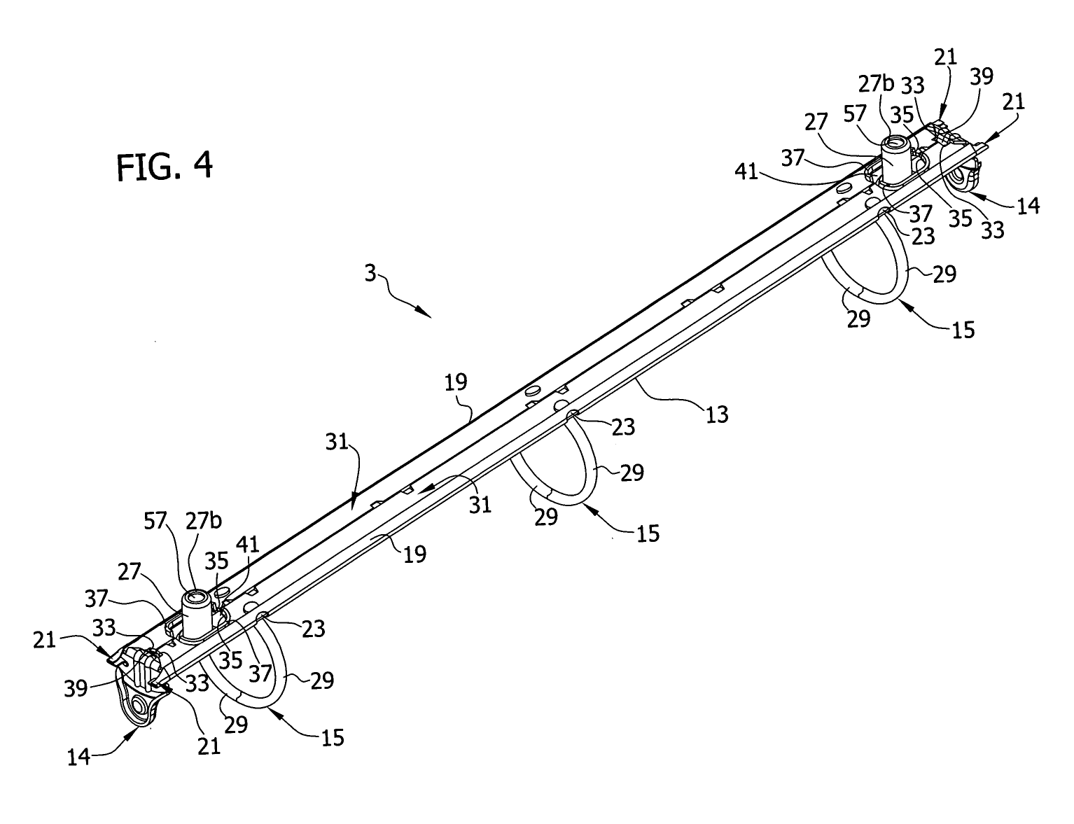

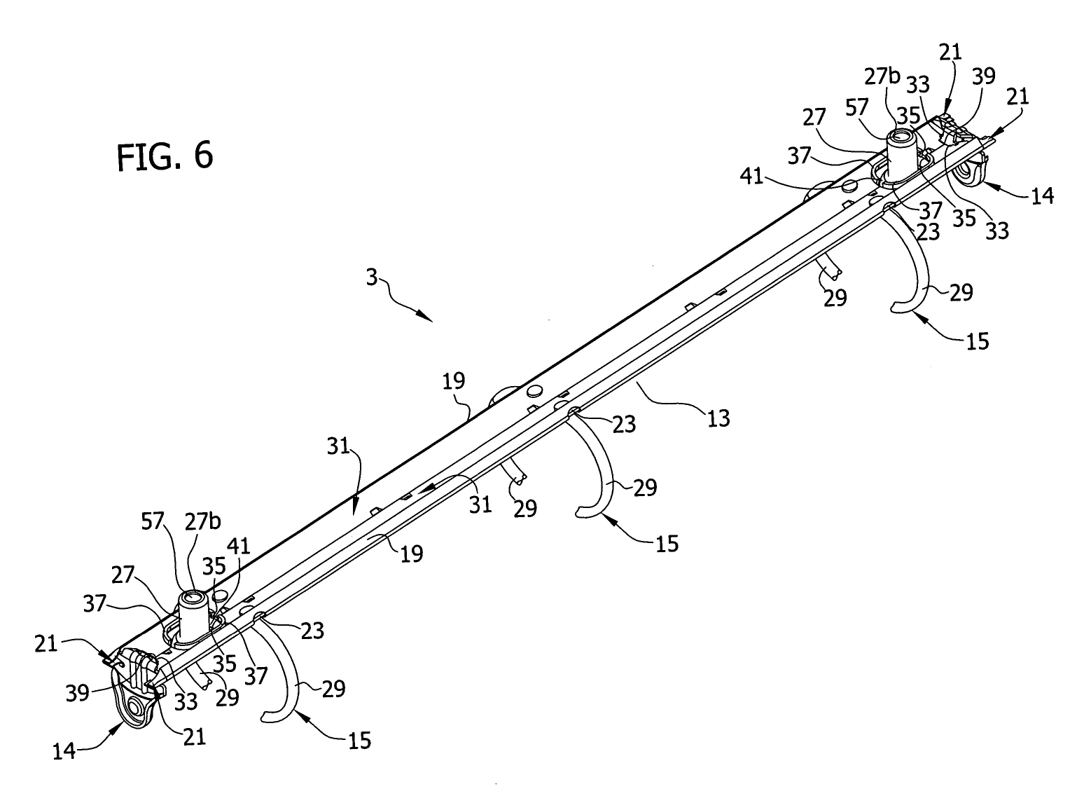

As shown in FIGS. 1-3C, the ring binder mechanism 3 includes an elongate housing 13 that supports two substantially similar actuating levers (each designated generally by reference numeral 14) and three rings (each designated generally by reference numeral 15). The housing 13 is symmetrical with a roughly arch-shaped cross section (see FIGS. 3A-3C) and includes a longitudinal axis LA2, two transversely opposite longitudinally extending edges, and two longitudinal ends (see FIG. 2). Each lever 14 pivotally mounts on the housing 13, generally at an opposite longitudinal end, for controlling movement of the rings 15 between a closed position (see FIG. 4) and an open position (see FIG. 6).

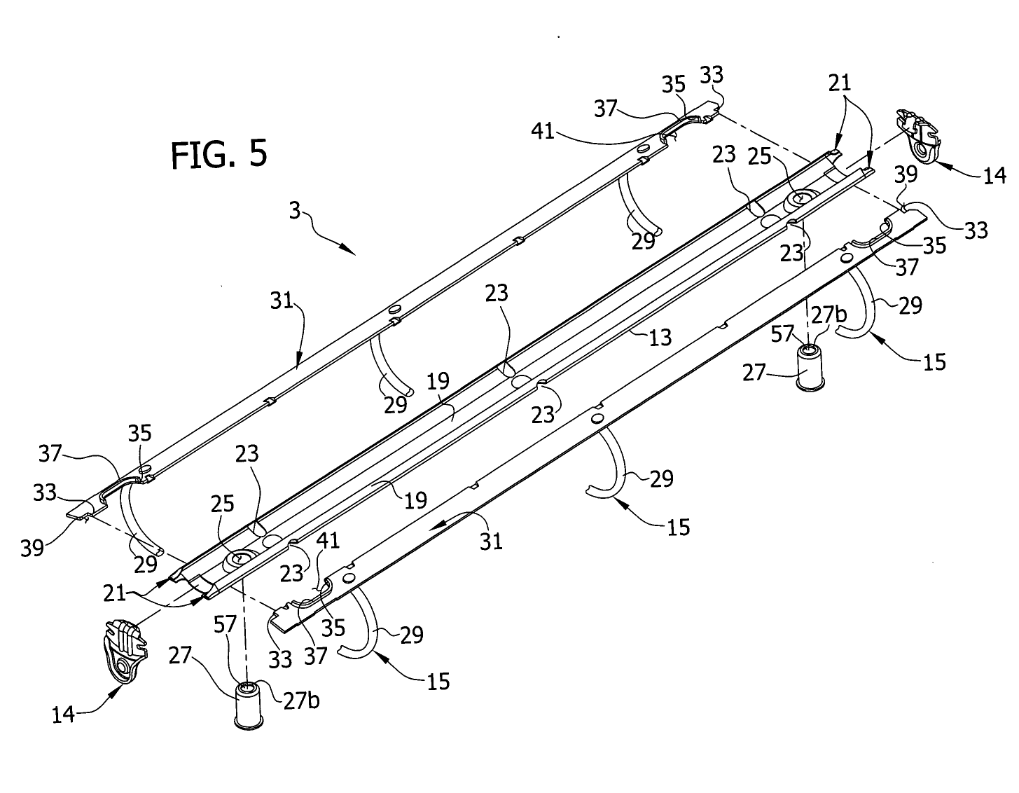

As best shown in FIGS. 4 and 5, a bent under rim 19 formed along each longitudinal edge of the housing 13 extends the full length of the housing from one longitudinal end to the other. Each end of the two bent under rims 19 is pinched together with a portion of an upper surface of the housing 13 to form four pockets (each pocket being designated by reference numeral 21). Accordingly, there are two pockets 21 adjacent each longitudinal end of the housing 13. Six total slots 23 are positioned along the two bent under rims 19. The slots 23 are arranged in three transversely opposed pairs with each pair receiving one of the rings 15 therethrough, allowing each ring to move laterally of the housing 13 for opening and closing. As shown in FIG. 2, two additional circular openings 25 are provided in the upper surface of the housing 13, near the longitudinal ends, each receiving and attaching two barrel bushings 27 (broadly, “mounting structures”) to the housing 13 for supporting the mechanism above the spine 5c of the cover 5. It is envisioned that the housing of the present invention is made of metal, but it may be made of any other suitable material that is sufficiently rigid to provide a stable mount for components of the mechanism. In addition, differently shaped housings, including asymmetrical ones, do not depart from the scope of this invention.

Each of the rings 15 includes two ring members 29, which are supported by the housing 13 for movement relative to one another between a closed position (see FIGS. 1 and 4) and an open position (see FIG. 6). In the closed position, the ring members 29 form a substantially continuous, closed, ring or loop for retaining loose-leaf pages and for allowing the pages to move along the rings 15 from one ring member 29 to the other. In the open position, each ring member 29 forms a discontinuous, open loop suitable for adding or removing pages. It is envisioned that the ring members are formed of a conventional, cylindrical rod of suitable material, such as steel. But it is understood that ring members having a different cross section or ring members made of different material do not depart from the scope of the present invention. Although in the illustrated mechanism both ring members can move, mechanisms having one movable ring member and one fixed do not depart from the scope of the invention. In addition, mechanisms with greater or fewer than three rings or with rings that form other shapes, such as slanted “D” shapes, when ring members are closed, do not depart from the scope of this invention.

As shown in FIGS. 4 and 5, the two ring members 29 of each ring 15 are mounted opposite each other on one of a pair of hinge plates (each hinge plate being designated generally by reference numeral 31). The hinge plates 31 are each thin and elongate, having an inner and an outer longitudinal edge margin and two longitudinal ends. Each hinge plate 31 additionally includes two squared notches 33 and two rounded cutouts 35, each of which are located along the inner longitudinal edge margin of the hinge plate. The two notches 33 are each located at a respective longitudinal end of the hinge plate 31, and the two cutouts 35 are each located inward from one of the respective notches 33 but still generally adjacent the hinge plate's ends. The cutouts 35 are each somewhat elongated and have a relatively straight side with two rounded ends. The side is receded into the hinge plate 31 and is roughly parallel to the hinge plate's inner and outer longitudinal edge margins. Reinforcing structure extends substantially around a perimeter of each cutout 35 for reinforcing the hinge plates 31 adjacent the cutouts. In the illustrated mechanism 1, this reinforcing structure is an upstanding rib 37. It is understood that the mechanism can have reinforcing structure with a different shape than that described and illustrated herein or no reinforcing structure without departing from the scope of the present invention.

Referring now to FIGS. 4 and 6, the hinge plates 31 attach to one another in parallel arrangement along their inner longitudinal edge margins, forming a central hinge having a pivot axis. The housing 13 loosely receives the outer longitudinal edge margins of the interconnected hinge plates 31 above its two bent under rims 19. Thus, the hinge plates 31 are retained on the housing 13 while the outer longitudinal edge margins are free to move within the rims 19. Corresponding notches 33 of the adjoining hinge plates align to form two box-shaped recesses 39 at opposite longitudinal ends of the plates 31. These recesses 39 are sized and shaped to interact with the actuating levers 14, as will be described in more detail hereinafter. Similarly, corresponding cutouts 35 align to form two roughly oval openings 41, each sized and shaped for receiving one of the barrel bushings 27 through the hinge plates 31. The ribs 37 of each cutout 35 align to substantially extend around a perimeter of each opening 41, rigidifying the interconnected hinge plates adjacent the openings and preventing them from bending during operation. In the illustrated mechanism, the box-shaped recesses 39 and the oval openings 41 are both symmetrically positioned about the pivot axis of the interconnected hinge plates 31. However, mechanisms in which openings and recesses are positioned differently about a pivot axis of interconnected hinge plates do not depart from the scope of the present invention.

The housing 13 is slightly narrower than the joined hinge plates 31 when the hinge plates are in a coplanar position (i.e., an angle between exterior surfaces of the hinge plates is 180°). So as the hinge plates 31 pivot through this position, they deform the resilient housing 13 and cause a spring force in the housing that urges the hinge plates 31 to pivot away from the coplanar position, either closing the ring members 29 (i.e., moving the pivot axis down and away from the housing's upper surface (FIG. 4)) or opening them (i.e., moving the pivot axis up and toward the housing's upper surface (FIG. 6)). Moreover, when the ring members 29 are closed, this spring force resists hinge plate movement and clamps the ring members together. When the ring members 29 are open, the spring force holds them apart. Thus, the illustrated embodiment uses a conventional arrangement to move the hinge plates 31 and ring members 29. It will be understood that other ways of moving the ring members 29 and locking them in a closed position or an open position may be used within the scope of the present invention.

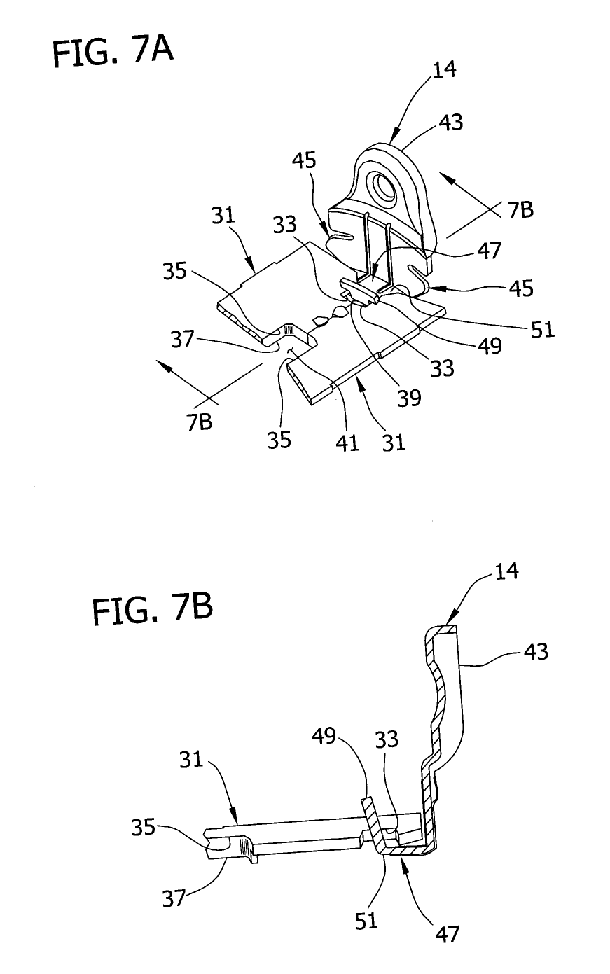

The two actuating levers 14 are shown in FIGS. 1, 4, 7A and 7B. Each lever 14 includes a relatively flat head 43 that extends upward, generally above the housing 13, for grasping to pivot the lever. Each additionally includes two lateral arms, each designated by reference numeral 45, and a cam, designated generally by reference numeral 47. As best shown in FIG. 7A, the lateral arms 45 extend laterally outward from opposite sides of each lever 14 below the flat head 43. The two arms 45 of each lever loosely fit within the two pockets 21 located at each longitudinal end of the housing 13, allowing the levers 14 to pivot within the pockets 21 relative to the housing about an axis transverse to the housing (FIGS. 4 and 6). Referring again to FIGS. 7A and 7B, the cam 47 of each lever is integrally attached to the lever 14 below the lateral arms 45. It extends downward from the arms 45 and curves outward from the flat head 43, fitting into one of the respective box-shaped recesses 39 of the hinge plates 31. An enlarged tab 49 of each cam fits loosely over the interconnected hinge plates 31 while a base 51 of each cam rests below the plates. Together, the tab 49 and base 51 capture the hinge plates 31 therebetween for operable engagement to control the pivoting motion of the hinge plates that close and open the ring members 29. In operation to close the ring members 29, the levers 14 are pivoted upward and inward. The tabs 49 engage a top surface of the hinge plates 31 and pull the pivot axis of the plates downward. To open the ring members 29, the levers 14 are pivoted outward and downward. The bases 51 engage a bottom surface of the hinge plates 31 and push the pivot axis of the plates upward. Mechanisms (not shown) having levers with different shapes or levers pivotally attached to a housing differently do not depart from the scope of the present invention. In addition, mechanisms having only one lever for driving the hinge plates do not depart from the scope of the present invention.

As mentioned above, the ring binder mechanism 3 is affixed to the cover 5 using a fastening system 7. The fastening system 7 of the configuration shown in FIGS. 1-7B comprises the two barrel bushings 27, two washers 53 (broadly, “bearing element’), and two snap fasteners, generally indicated at 55. The two barrel bushings 27, as shown in FIGS. 1 and 2, are located adjacent the levers 14 and space the ring binder mechanism from the cover 5 so that the hinge plates 31 can pivot without engaging the spine 5c. In this position, the bushings 27 align with the oval openings 41 of the interconnected hinge plates 31 and pass through the hinge plates without interfering with their operation. Each barrel bushing 27 is tubular in shape and has two open ends. At a first end, the barrel bushing 27 includes a deformable lip 27a that attaches the bushing to one of the circular openings 25 in the upper surface of the housing 9. It will be understood that other ways of attaching the bushings 27 to the housing 13 may be used without departing from the scope of the present invention. At a second end, the bushing 27 includes a circular rim 27b defining an aperture 57 in the second end. It is understood that the fastening system can have more or fewer barrel bushings, washers, and snap fasteners without departing from the scope of this invention.

As shown in FIGS. 2 and 3A-3C, the washers 53 are disposed between the barrel bushings 27 and spine 5c of the cover 5 to distribute the load associated with the bushings over a larger area of the cover 5. In this configuration, the washers 53 are sized and shaped to cover the circular recesses 11 and accommodate the apertures 12 in the spine 5c of the cover 5. Accordingly, each washer 53 has a central cup-shaped portion 63 sized for receiving the second end of the barrel bushing 27 and an annular flange 61 extending generally around the cup-shaped portion. In use, the cup-shaped portions 63 are generally received in respective circular recesses 11 while the flange 61 covers a portion of the spine 5c adjacent the circular recess. As a result, the washers 53 prevent direct contact between the barrel bushings 27 of the ring binder mechanism 3 and the spine 5c of the cover 5. The barrel bushings 27 contact the washers 53. An aperture 65 in each of the cup-shaped portions 63 of the washers 53 aligns with and has a slightly smaller diameter than the respective aperture 12 in the spine 5c so that the washer provides some protection to an edge of the recess in the spine defining the aperture. It is understood that some embodiments of the present invention (not shown) are free of washers 53. In these embodiments, the barrel bushings 27 are in direct contact with the cover 5.

As shown in FIG. 3A-3C, each of the two snap fasteners 55 is passed through the apertures 12 in the spine 5c of the cover 5, the washers 53, and the barrel bushings 27 (only one of the snap fasteners and barrel bushings is shown) for securing the ring binder mechanism 3 to the cover 5. Each of the snap fasteners 55 includes a shaft 67 having a rounded free end 69, and a head 70 attached to other end of the shaft (i.e., the end opposite the free end). The free end 69 is rounded to make it easier to insert the shaft 67 of the snap fastener 55 through the apertures 12, 65, 57 in the spine 5c, washer 53, and barrel bushing 27. The shaft 67 includes a plurality of annular ribs 71 extending outwardly along the length of the shaft. The illustrated snap fastener 55 has three, evenly spaced ribs 71. It is understood, however, that the snap fastener could have more or fewer ribs and that the spacing between ribs could be varied. Each of the ribs 71 have a curved surface 73 and a substantially flat surface 75. The flat surface 75 is positioned nearer the head 70 of the fastener 55 than is the curved surface 73. The head 70 of the snap fastener 55 has a rounded outer surface 77 and a substantially flat inner surface 79.

The ribs 71 of the snap fastener 55 are resiliently deformable and have a width W1 greater than a width W2 of the aperture 57 in the barrel bushings 27. As shown in FIG. 3B, when the ribs 71 of the snap fastener 55 are being pushed through the aperture 57 in the barrel bushings 27 the ribs deform (i.e., deflect axially along the shaft towards the head) thereby allowing the wider ribs to pass through the aperture. As the ribs 71 are being pushed through the aperture 57 in the barrel bushing 27, the curved surface 73 of the rib engages and slides along an edge of the barrel bushing 27 defining the aperture 57 thereby facilitating the deformation of the rib. Once the ribs 71 gets past the edge of the barrel bushing 27, the ribs substantially returns to their original shape (FIG. 3C). Once inserted, the flat surface 75 of the rib 71 is in face-to-face contact with an interior side of the rim 27a of the second end of the barrel bushing 27 and the flat surface 79 of the head 70 is in face-to-face contact with an outer surface of the spine 5c of the cover 5. The flat surface 75 of the rib 71 in engagement with the rim 27a resists deformation of the rib. As a result, the barrel bushings 27, washers 53, and cover 5 are securely held together and the snap fasteners 55 are inhibited from being withdrawn.

Ring binders 1 of the present invention can be easily and manually assembled. First, the washers 53 are aligned with and placed in the recesses 11 in the spine 5c of the cover 5. Next, the ring binder mechanism 3 is positioned so that the apertures 57 in the barrel bushings 27 are aligning with the apertures 65, 12 in the washer 53 and cover 5. Lastly, the shaft 67 of each of the snap fasteners 55 is inserted by hand through the apertures 12, 65, 57 in the cover, washer and barrel bushings so that the flat surface 75 of the rib 71 is placed in face-to-face contact with the interior side of the rim 27b of the second end of the barrel bushing 27 and the flat surface 79 of the head 70 is placed in face-to-face contact with an outer surface of the spine 5c of the cover 5 to thereby secure the ring binder mechanism 3 to the cover.

Accordingly, ring binders 1 of the present invention can be packaged, shipped, stored and/or sold without having the ring binder mechanism 3 securely attached to the covers 9. For example, multiple covers 5 can be packaged and shipped together such that little space between adjacent covers is wasted. This can be done by lying the covers 5 flat such that the front panel 5a, back panel 5b, and spine 5c are all substantially in the same plane and stacking others on top. The ring binder mechanisms 3 can be packaged in the same container as the covers 5 or separately. Either way, the ring binder mechanism 3 can also be arranged to minimize wasted space. One possible packing arrangement for the ring binder mechanisms 3 is to pack them in alternating directions such that the rings 15 of one mechanism are positioned between the rings of an adjacent mechanism. As a result, the separated covers 5 and ring binder mechanisms 3 can be packaged, shipped, and stored more efficiently and cost effectively than ring binders having the ring binder mechanisms attached.

The ring binder mechanisms 3 can be attached to the covers 9, for example, by the retailer prior to transferring them to a customer (i.e, after a sale) or before placing them on display. It is also understood that the customer may wish to maintain the ring binder mechanisms 3 and covers 5 separately to take advantage of the saved storage space. Thus, the customer may be the one who attaches the ring binder mechanism 3 to the cover 5. Accordingly, it is understood that the ring binder mechanism and cover of the present invention can be joined to form a ring binder at any of various times. The examples of the ring binder mechanism being attached to the cover by a retailer and a customer are exemplary only as it is understood that other individuals, including the ring binder manufacturer, may assemble the ring binder. It is also understood that the ring binder mechanism could be attached to the cover using an automated process as well as the manual process described herein.

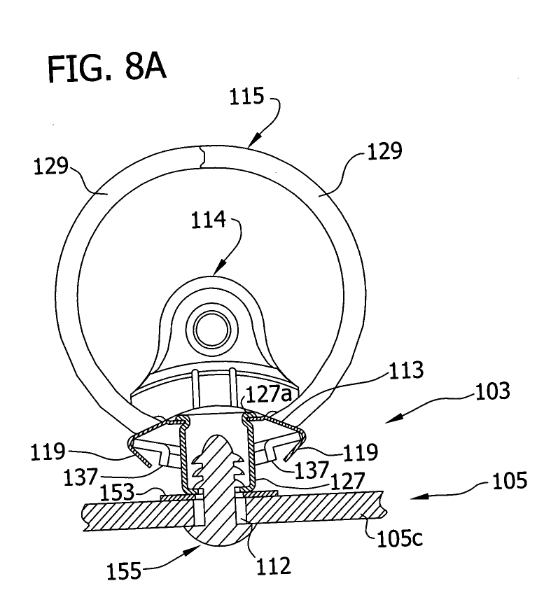

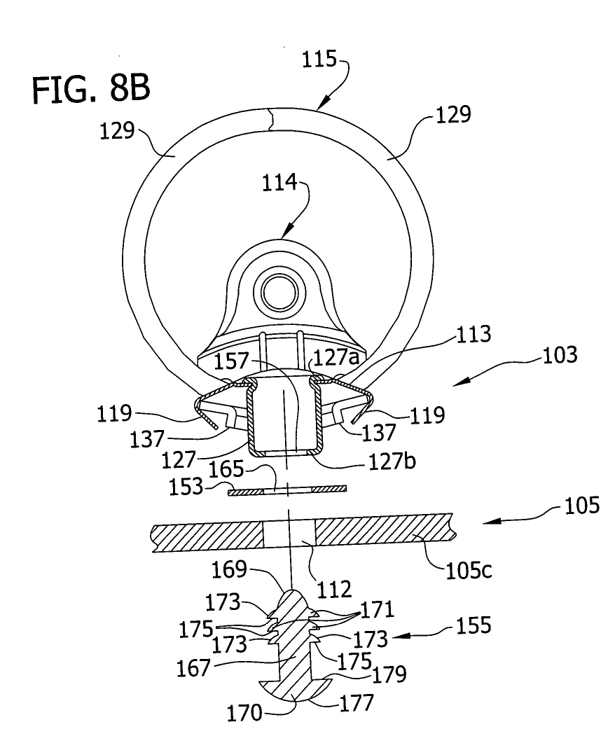

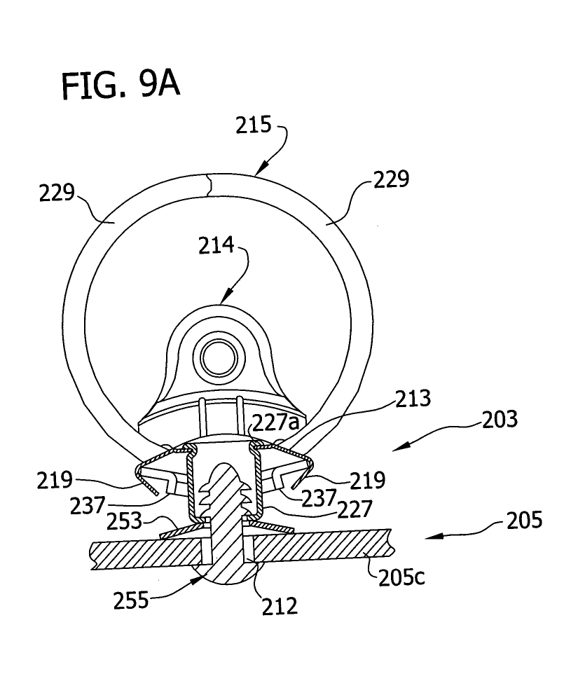

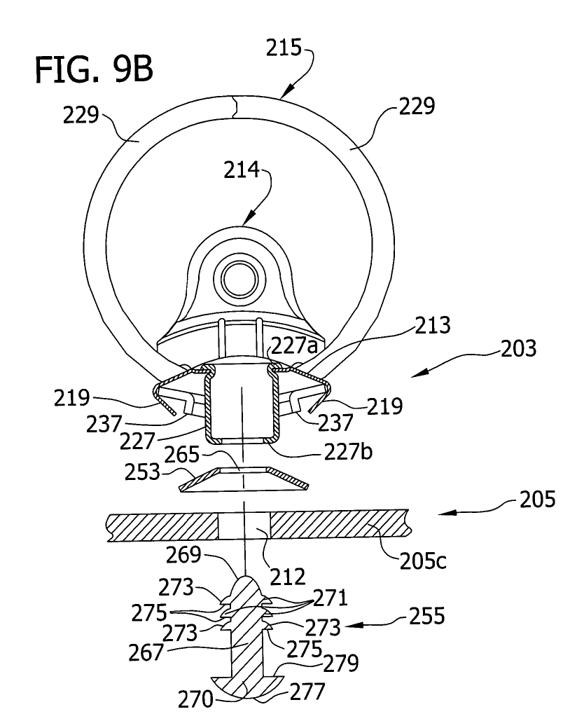

Other configurations of washers 153 and cover 105 are show in FIGS. 8A and 8B. This ring binder 101 is substantially similar to the previously described ring binder except that the washers 153 in this configuration are substantially flat and the cover 105 does not contain circular recesses. Corresponding parts are indicated by the same reference numbers used for the ring binder shown in FIGS. 1-7B plus “100.” FIGS. 9A and 9B shown yet another configuration of a ring binder 201 that is substantially similar to the one shown in FIGS. 8A and 8B except that the washers are spring washers 253 (e.g., Belleville washers). The spring washer 253 is used to apply a tension to the fastening system along the axis of the fastener 255. As a result and as illustrated in FIG. 9A, each spring washer 253, which is slightly compressed, bias the second end of the corresponding barrel bushing 227 against the flat surface 275 of the rib 271 and the cover 205 against the flat surface 279 of the head 270. As a result, snap fasteners 255 in this configuration have less potential for axial play as compared to the snap fasteners in other configurations. Corresponding parts are indicated by the same reference numbers used for the ring binder shown in FIGS. 1-7B plus “200.”

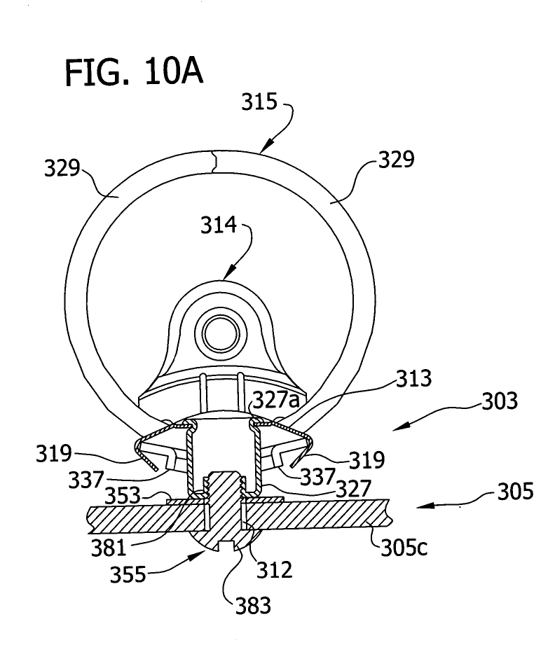

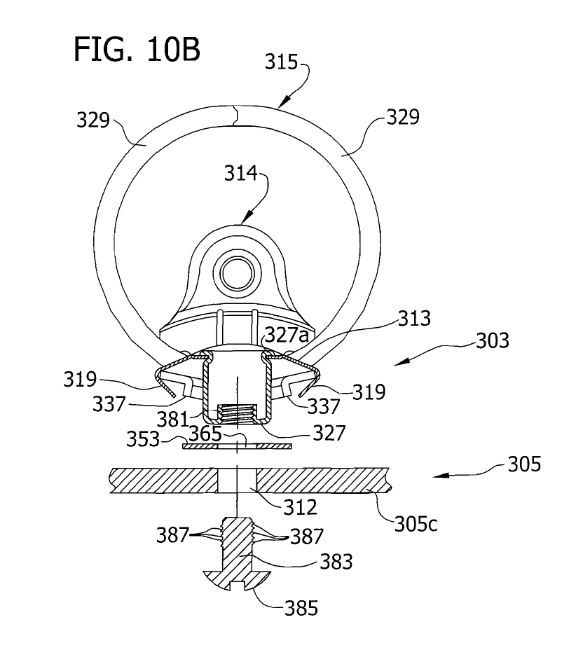

FIGS. 10A and 10B show yet still another configuration of the ring binder 301 of the present invention having a ring binder mechanism 303 and a cover 305. In this configuration, a second end of a barrel bushing 327 has a threaded socket 381 for receiving threads of a fastener 383 (e.g., bolt). The fastener 383 has a head 385 at one end and threads 387 at the other end. To secure the ring binder mechanism 303 to the cover 305, the threaded end of the fastener 383 is passed through apertures 312, 365 in the cover 305 and the washer 353 for connection with the threads of the socket 381. Thus, the ring binder 301 of this configuration can be assembled using a conventional tool (e.g., boltdriver, allen wrench). Moreover, the rind binder 301 can be nondestructively disassembled by unscrewing the fastener 383 from the socket 381 to thereby free the ring binder mechanism 303 from the cover 305. Corresponding parts are indicated by the same reference numbers used for the ring binder shown in FIGS. 1-7B plus “300.”

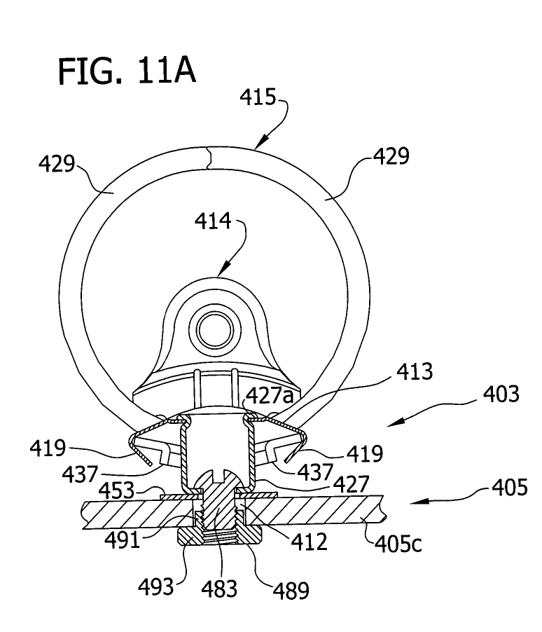

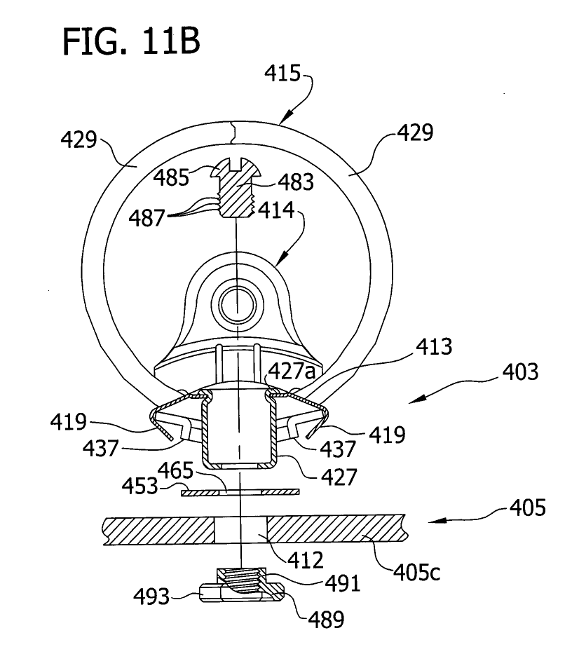

FIGS. 11A and 11B show a further configuration of the ring binder 401 of the present invention. In this configuration, a bolt 483 is placed in a barrel bushing 427 attached to a ring binder mechanism 403 such that a threaded end of the bolt 483 extends outwardly from the barrel bushing 427. The threaded end of the bolt 483 is then inserted through apertures 465, 412 in a washer 453 and a cover 405. A threaded nut 489 engages the exterior of the cover 405 and mates with the threaded end of the bolt 483 to secure the ring mechanism 403 to the cover. The illustrated nut 489 is shown have two body segments 491, 493. One of the body segments is relatively narrow 491 so that it can be received in the aperture 412 in the cover 405. The other body segment 493 of the nut 489 is wider to engage the spine 405c and inhibit the nut from passing through the aperture 412. It is understood, however, that the nut can have other shapes and configurations. The ring binder of this configuration can also be assembled using conventional tools (e.g., boltdriver, allen wrench, wrench). The tool can be received through the opening 425 in the housing 413 and through the bushing 427 to access the head of the bolt 483. Corresponding parts are indicated by the same reference number used for the ring binder shown in FIGS. 1-7B plus “400.”

Components of the mechanism of the present invention are made of a suitable rigid material, such as metal (e.g., steel). But mechanisms made of a non-metallic material, specifically including plastic, do not depart from the scope of this invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. Moreover, the use of “up” and “down” and variations thereof is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

1. A ring binder mechanism comprising:
an elongate housing;
at least one ring for mounting loose leaf paper, the ring including first and second ring members, each of the ring members being supported by the housing for movement relative to each other between a closed position in which the ring members form a substantially continuous, closed loop for allowing loose-leaf paper retained by the ring to be moved along the ring from one ring member to the other, and an open position wherein the ring members of the ring form a discontinuous, open loop for adding or removing loose-leaf paper from the ring;
at least one mounting structure extending outwardly from the housing and having first and second ends, the first end being adapted for attachment to the housing and the second end having an aperture therein;
a bearing element having an opening therein, the bearing element having a width greater than the width of the mounting structure at the second end; and
a fastener adapted for reception through the bearing element opening and through the mounting structure aperture at the second end for securing the housing to a substrate with the bearing element generally interposed between the second end of the mounting structure and the substrate.

2. The ring binder mechanism as set forth in claim 1 wherein the bearing element has a greater surface area than the second end of the mounting structure for distributing a load associated with the securement of the housing to the substrate.

3. The ring binder mechanism as set forth in claim 2 wherein the bearing element includes a central cup-shaped portion sized and shaped for receiving the second end of the mounting structure.

4. The ring binder mechanism as set forth in claim 3 wherein the bearing element further includes an annular flange extending generally around the cup-shaped portion.

5. The ring binder mechanism as set forth in claim 4 wherein the bearing element opening is located in the cup-shaped portion.

6. The ring binder mechanism as set forth in claim 2 wherein the bearing element is substantially flat.

7. The ring binder mechanism as set forth in claim 2 wherein the bearing element comprises a spring washer.

8. The ring binder mechanism as set forth in claim 1 wherein a portion of the fastener is resiliently deformable and has a width greater than a width of the aperture in the mounting structure so that when the resiliently deformable portion of the fastener is pushed through the aperture in the mounting structure, the deformable portion of the fastener deforms thereby allowing the portion to pass the aperture, the deformable portion of the fastener being adapted to substantially return to its original width after insertion through the aperture in the mounting structure to inhibit withdrawal of the portion from the mounting structure.

9. The ring binder mechanism as set forth in claim 8 wherein the fastener comprises a shaft and a head attached to an end the shaft, the shaft having at least one rib extending around at least a portion of the circumference of the shaft, the rib of the shaft being spaced from the head.

10. The ring binder mechanism as set forth in claim 9 wherein deformable portion of the fastener includes the rib.

11. The ring binder mechanism as set forth in claim 9 wherein the mounting structure comprises a barrel bushing, the barrel bushing being adapted to space the housing away from the substrate when the housing is attached to the substrate.

12. The ring binder mechanism as set forth in claim 11 wherein the rib of the fastener is adapted to contact the barrel bushing, and the head of the fastener is adapted to contact the substrate to thereby affix the barrel bushing to the substrate.

13. The ring binder mechanism as set forth in claim 1 wherein the fastener comprises a bolt having a threaded shaft and a head attached to the shaft.

14. The ring binder mechanism as set forth in claim 13 wherein the mounting structure has threads adjacent its second end for engaging the threads of the bolt.

15. The ring binder mechanism as set forth in claim 1 in combination with a cover defining the substrate.

16. The combination as set forth in claim 15 wherein the cover comprises a front panel, a back panel, and a spine, the front and back panels being hingedly attached to the spine so that the panels are movable to selectively cover or expose loose leaf pages capable of being retained by the ring binder mechanism, the cover receiving the fastener for attaching the ring binder mechanism to the cover.

17. The combination as set forth in claim 16 wherein the cover includes at least one aperture positioned for allowing the deformable portion of the fastener to pass the aperture to the bearing element and mounting structure.

18. The combination as set forth in claim 17 wherein the cover further comprises at least one circular recess and the cover aperture being located in the recess.

19. A ring binder mechanism comprising:
an elongate housing;
at least one ring for mounting loose leaf paper, the ring including first and second ring members, each of the ring members being supported by the housing for movement relative to each other between a closed position in which the ring members form a substantially continuous, closed loop for allowing loose-leaf paper retained by the ring to be moved along the ring from one ring member to the other, and an open position wherein the ring members of the ring form a discontinuous, open loop for adding or removing loose-leaf paper from the ring;
at least one mounting structure associated with the housing; and
a snap fastener constructed for snap connection with the mounting structure to secure the ring binder mechanism to a substrate.

20. The ring binder mechanism as set forth in claim 19 wherein the fastener includes a resiliently deformable portion adapted to deform and recover upon engagement with the mounting structure for snap connection therewith.

21. The ring binder mechanism as set forth in claim 20 wherein the mounting structure includes an aperture, the fastener deformable portion having an undeformed width greater than a width of the aperture, the deformable portion being received through the aperture when the fastener connects mounting structure to the substrate.

22. The ring binder mechanism as set forth in claim 21 wherein the fastener comprises a shaft and a head attached to an end the shaft, the shaft having at least one rib extending around at least a portion of the circumference of the shaft, the rib of the shaft being spaced from the head.

23. The ring binder mechanism as set forth in claim 22 wherein deformable portion of the fastener includes the rib.

24. The ring binder mechanism as set forth in claim 22 wherein the mounting structure comprises a barrel bushing, the barrel bushing being adapted to space the housing away from the substrate when the housing is attached to the substrate.

25. The ring binder mechanism as set forth in claim 24 wherein the rib of the fastener is adapted to contact the barrel bushing, and the head of the fastener is adapted to contact the substrate to thereby affix the barrel bushing to the substrate.

26. A ring binder mechanism comprising:
an elongate housing;
at least one ring for mounting loose leaf paper, the ring including first and second ring members, each of the ring members being supported by the housing for movement relative to each other between a closed position in which the ring members form a substantially continuous, closed loop for allowing loose-leaf pages retained by the ring to be moved along the ring from one ring member to the other, and an open position wherein the ring members of the ring form a discontinuous, open loop for adding or removing loose-leaf pages from the ring;
at least one mounting structure extending outwardly from the housing and having first and second ends, the first end being adapted for attachment to the housing; and
a fastener selectively engageable with the second end of the mounting structure for securing the ring binder mechanism to the substrate, at least one of the fastener and mounting structure being formed for nondestructive disengagement of the fastener with the second end of the mounting structure for releasing the ring binder mechanism from the substrate.

27. The ring binder mechanism as set forth in claim 26 wherein the fastener is a bolt having a head and a threaded shaft attached to the head.

28. The ring binder mechanism as set forth in claim 27 wherein the mounting structure has threads adjacent its second end for engaging the threads of the bolt.

29. A method of attaching a ring binder mechanism to a cover to form a ring binder, the ring binder mechanism comprising a housing including at least one ring for mounting loose leaf paper thereon and at least one mounting structure extending outwardly from the housing, the mounting structure having an aperture and the cover having at least one aperture therein, the method comprising the steps of:
positioning a bearing element having an opening relative to the cover so that the opening in the bearing element is generally aligned with the aperture in the cover;
aligning the aperture in the mounting structure of the ring binder mechanism with the opening in the bearing element and the aperture in the cover; and
inserting a fastener through the aperture in the cover, the opening in the bearing element and the aperture in the mounting structure to thereby secure the ring binder mechanism to the cover.

30. The method as set forth in claim 29 wherein the step of positioning a bearing element comprises placing a cup-shaped portion of the bearing element in a recess in the cover.

31. The method as set forth in claim 29 wherein the step of aligning the aperture in the mounting structure of the ring binder mechanism with the opening in the bearing element includes securing the mounting structure to a central cup-shaped portion in the bearing element.

32. A ring binder mechanism comprising:
an elongate housing;
at least one ring for mounting loose leaf paper, the ring including first and second ring members, each of the ring members being supported by the housing for movement relative to each other between a closed position in which the ring members form a substantially continuous, closed loop for allowing loose-leaf paper retained by the ring to be moved along the ring from one ring member to the other, and an open position wherein the ring members of the ring form a discontinuous, open loop for adding or removing loose-leaf paper from the ring;
at least one mounting structure extending outwardly from the housing and having first and second ends, the first end being adapted for attachment to the housing and the second end having an aperture therein;
a receiver affixed to the mounting structure, and
a fastener adapted for connection with the receiver for securing the housing to a substrate.

33. The ring binder mechanism as set forth in claim 32 wherein the receiver is a threaded socket and the fastener is a threaded bolt adapted for connection with the threaded socket.

34. The ring binder mechanism as set forth in claim 32 wherein the receiver is formed as one piece with the mounting structure.
